(19) United States
(12) Patent Application Publication
(10) Pub. No.: US 2025/0042770 A1
(43) Pub. Date: Feb. 6, 2025

(54) WATER PURIFICATION SYSTEM

(71) Applicant: KYUNGDONG NAVIEN CO., LTD., Pyeongtaek-si, Gyeonggi-do (KR)

(72) Inventors: Young Jo Lim, Seoul (KR); Soo Young Lee, Seoul (KR)

(21) Appl. No.: 18/714,050

(22) PCT Filed: Oct. 31, 2022
(86) PCT No.: PCT/KR2022/016836

§ 371 Date: May 28, 2024

(30) Foreign Application Priority Data
Nov. 29, 2021 (KR) 10-2021-0167117

(51) Int. Cl. C02F 1/00

(52) U.S. Cl. CPC C02F 1/001; C02F 2201/005; C02F 2209/005; C02F 2209/03; C02F 2209/40

(57) ABSTRACT

The present invention relates to a water purification system. The water purification system comprises: a filter unit which has a raw water area for receiving raw water, and a purified water area for accommodating purified water produced by filtering at least a portion of the raw water from the raw water area, and which is provided to separate the raw water into waste water and purified water to be discharged; and a flushing tank provided to receive and store purified water from the purified water area and supply the stored purified water to the raw water area, wherein after being introduced into the flushing tank from the purified water area, at least a portion of the purified water supplied from the flushing tank to the raw water area may be re-filtered and then discharged from the purified water area to be re-introduced into the flushing tank.

### TECHNICAL FIELD

The present disclosure relates to a water purification system.

### BACKGROUND ART

A water purifier is a device that removes contaminants, ions, odors, turbidity, and the like from water and supplies it to the user.

When foreign substances in water are removed through filtration and are supplied to users, the water purifier includes a water filter for filtering the water. As an example of these water filters, there is a reverse osmosis filter that is provided with a reverse osmosis membrane. The reverse osmosis causes the water to pass through the reverse osmosis membrane at a specific pressure to filter the water while the water is introduced. Furthermore, the ions that has not passed through the reverse osmosis membrane are drained into a wastewater line together with water that has passed therethrough.

Accordingly, with respect to the reverse osmosis membrane, water of high total dissolved solids (TDS) concentration, that is, the water containing ions that have not passed is present on one side, and water of a low TDS concentration, that is, the filtered water, from which the ions are removed, is present on opposite side.

Meanwhile, while water is not filtered through the reverse osmosis filter, water on a filtration side of the reverse osmosis filter flows to a non-filtration side due to an osmotic pressure. Accordingly, the TDS concentration of the water on the filtration side of the reverse osmosis filter increases and becomes similar to the TDS concentration of water on the non-filtration side.

In this state, when the water filtration is resumed through the reverse osmosis filter, the water with a high TDS concentration that is present on the filtration side of the reverse osmosis filter is initially supplied to the user, and this phenomenon is called a creep phenomenon.

In the case of a general water purifier, to reduce the creep phenomenon, a volume of the wastewater side is minimized, the wastewater side water is removed, or a flushing method is used. When the volume of the wastewater is minimized, assembly is structurally inefficient. In the case of the wastewater removal method, a recovery ratio and a TDS fluctuate because a flow rate of purified water is unstable at the beginning of operation.

Finally, in the case of the flushing method, the flushing water is collected and the flushing water is discarded toward the wastewater while an outlet side is closed. In this case, there is a limit to a capacity of the flushing water, and when the flushing water is used up, the TDS on the wastewater side has to be lowered by introducing source water whereby even through width may be reduced, a concentration difference is inevitably present. Accordingly, during extraction after stagnation, there is a limit in minimizing the increase in the initial TDS.

Accordingly, when the flushing method is to be utilized, a technology that may minimize the difference in the TDS between the purified water and the wastewater is needed.

### DISCLOSURE

### Technical Problem

An aspect of the present disclosure provides a water purification system that may minimize a TDS difference between purified water and wastewater during flushing.

### Technical Solution

An aspect of the present disclosure provides a water purification system including a filter part having a source water area for receiving source water and a purified water area for accommodating purified water generated by filtering at least a portion of the source water of the source water area, and that separates and discharges the source water into wastewater and the purified water, and a flushing tank that receives and stores the purified water of the purified water area, and supplies the stored purified water to the source water area, at least a portion of the purified water introduced from the purified water area into the flushing tank, and then supplied from the flushing tank to the source water area is filtered again, discharged from the purified water area, and then reintroduced into the flushing tank.

In another embodiment, the water purification system may further include a wastewater line, through which the waste water of the source water area is discharged to an outside, and a wastewater valve disposed in the wastewater line, and that controls a flow rate of the wastewater discharged through the wastewater line depending on an opening degree thereof, and a recovery ratio being a ratio of the purified water and the wastewater discharged may be controlled depending on the opening degree of the wastewater valve.

In another embodiment, the water purification system may further include a water introduction line, through which the source water is supplied from the water source to the source water area, a water discharge line, through which the purified water of the purified water area is discharged to a source of demand, a flushing tank introduction line branched from the water discharge line, and through which the purified water is discharged to the flushing tank, and a flushing tank discharge line, through which the stored purified water of the flushing tank is discharged to the source water area.

In another embodiment, the water purification system may further include a water introduction valve disposed in the water introduction line, in which the water introduction line is disposed on an upstream side of a first connection point connected to the flushing tank discharge line, and that selectively blocks introduction of the source water, a water discharge valve disposed in the water discharge line, in which the flushing tank introduction line is disposed on a downstream side of a second connection point branched from the water discharge line, and that selectively blocks discharge of the purified water to the source of demand, a flushing valve disposed in the flushing tank discharge line, and that selectively opens and closes the flushing tank discharge line while being opened and closed, and a pump disposed in the water introduction line, disposed on a downstream side of the first connection point, and that pumps water in the water introduction line toward the source water area.

In another embodiment, in a purified water supply mode for supplying the purified water in the purified water area to a user, the water introduction valve and the water discharge valve may be opened, the flushing valve may be closed, an operation of the pump may be initiated to pump the water in the water introduction line to the source water area, and the wastewater valve may be opened by a degree, at which the recovery ratio corresponds to a first recovery ratio.

In another embodiment, when the purified water supply mode is maintained for a first reference time period, the wastewater valve may be opened by a degree, at which the recovery ratio corresponds to a second recovery ratio being a recovery ratio, at which a discharge ratio of the wastewater is higher than the first recovery ratio.

In another embodiment, when the purified water supply mode is ended after the first reference time period and then a first drain mode for discharging the wastewater through the wastewater line is entered, the water introduction valve, the water discharge valve, and the flushing valve may be closed, the operation of the pump may be ended, and the wastewater valve may be opened by a degree, at which the recovery ratio corresponds to the second recovery ratio.

In another embodiment, after the first drain mode is ended and then a storage mode for storing the purified water in the flushing tank is entered, the water introduction valve may be opened, and the operation of the pump may be initiated.

In another embodiment, when storage of the purified water in the flushing tank is ended, and then a flushing mode for sending the stored purified water to the filter part is entered, the water introduction valve may be closed, the flushing valve may be opened, and the wastewater valve may be opened by a degree, at which the recovery ratio corresponds to a third recovery ratio being a recovery ratio, at which a discharge ratio of the wastewater is higher than the first recovery ratio and the discharge ratio of the wastewater is lower than the second recovery ratio.

In another embodiment, when a first purified water resupply mode for supplying the purified water to an outside in the first drain mode, the storage mode, or the flushing mode is entered, the water introduction valve and the water discharge valve may be opened, the flushing valve may be closed, the operation of the pump may be initiated to pump the water in the water introduction line to the filter part, and the wastewater valve may be opened by a degree, at which the recovery ratio corresponds to the second recovery ratio.

In another embodiment, when the flushing mode is maintained for a second reference time period and then a standby mode is entered, the flushing valve may be closed, the operation of the pump may be ended, and the wastewater valve may be opened by a degree, at which the recovery ratio corresponds to the first recovery ratio.

In another embodiment, the storage mode may be configured to be reentered when the standby mode is maintained for a third reference time period.

In another embodiment, when the purified water supply mode is ended before the first reference time period elapses and then a second drain mode for discharging the wastewater through the wastewater line is entered, the water introduction valve, the water discharge valve, and the flushing valve may be closed, the operation of the pump may be ended, and the wastewater valve may be opened by a degree, at which the recovery ratio corresponds to the first recovery ration.

In another embodiment, when, after the second drain mode, a second purified water resupply mode for supplying the purified water to an outside within a third reference time period is not entered and a storage mode for storing the purified water to the flushing tank is entered, the water introduction valve may be opened, the operation of the pump may be initiated, and the wastewater valve may be opened by a degree, at which the recovery ratio corresponds to a second recovery ratio being a recovery ratio, at which a discharge ratio of the wastewater is higher than the first recovery ratio.

In another embodiment, when storage of the purified water in the flushing tank is ended and then a flushing mode for sending the stored purified water to the filter part is entered, the water introduction valve and the flushing valve may be opened, and the wastewater valve may be opened by a degree, at which the recovery ratio corresponds to a second recovery ratio being a recovery ratio, at which a discharge ratio of the wastewater is higher than the first recovery ratio.

In another embodiment, when, after the second drain mode, a second purified water resupply mode for supplying the purified water to an outside within a third reference time period is entered, the water introduction valve and the water discharge valve may be opened, and the operation of the pump may be initiated.

In another embodiment, the flushing tank may include an outer tank having a space in an interior thereof, and an inner tank inserted into an interior of the outer tank, connected to the flushing tank introduction line and the flushing tank discharge line, and a volume of which is changeable by an amount of the water introduced from the flushing tank introduction line and an amount of the water discharged through the flushing tank discharge line.

In another embodiment, the flushing tank may further include a pressure sensor attached to an inner wall of the outer tank, and that detects a change in the applied pressure.

In another embodiment, the water purification system may further include a water introduction valve disposed in the water introduction line, the water introduction line being disposed on an upstream side of a first connection point connected to the flushing tank discharge line, and that selectively blocks introduction of the source water, a flushing valve disposed in the flushing tank discharge line, and that selectively opens and closes the flushing tank discharge line while being opened and closed, a wastewater valve disposed in the wastewater line, and that controls the flow rate of the wastewater discharged through the wastewater line depending on an opening degree thereof, and a controller that controls opening and closing of the water introduction valve, the flushing valve, and the wastewater valve based on the pressure acquired by the pressure sensor.

In another embodiment, the controller may be configured to, when the pressure acquired by the pressure sensor is a reference pressure or higher, control the water introduction valve to close the opened water introduction valve, control the flushing valve to open the closed flushing valve, and control an opening degree of the wastewater valve to decrease the flow rate of the wastewater discharged through the wastewater line.

### Advantageous Effects

According to the present disclosure, a portion of the flushing water may be filtered again and be reintroduced into the filter whereby the TDS of the water introduced into the filter may be kept low and a creep phenomenon may be minimized.

### DESCRIPTION OF DRAWINGS

FIG. 1 is a water piping diagram of a water purification system according to an embodiment of the present disclosure.

FIG. 2 is a flowchart illustrating an operation sequence of a water purification system according to an embodiment of the present disclosure.

FIG. 3 is a view illustrating a purified water supply mode.

FIG. 4 is a view illustrating that a purified water supply mode is maintained for a first reference time period or more.

FIG. 5 is a view illustrating a first drain mode.

FIG. 6 illustrates a storage mode.

FIG. 7 is a view illustrating a flushing mode.

FIG. 8 is a view illustrating a standby mode.

FIGS. 9 and 10 are enlarged views of a flushing tank.

### MODE FOR INVENTION

This application claims the benefit of priority to Korean Patent Application No. 10-2021-0167117, filed in the Korean Intellectual Property Office on Nov. 29, 2021, the entire contents of which are incorporated herein by reference.

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

Meanwhile, in the present disclosure, the expressions an upstream side and a downstream side may be with respect to a direction of a flow of a fluid. For example, when a fluid flows from a left side to a right side, the left side may correspond to the upstream side and the right side may correspond to the downstream side.

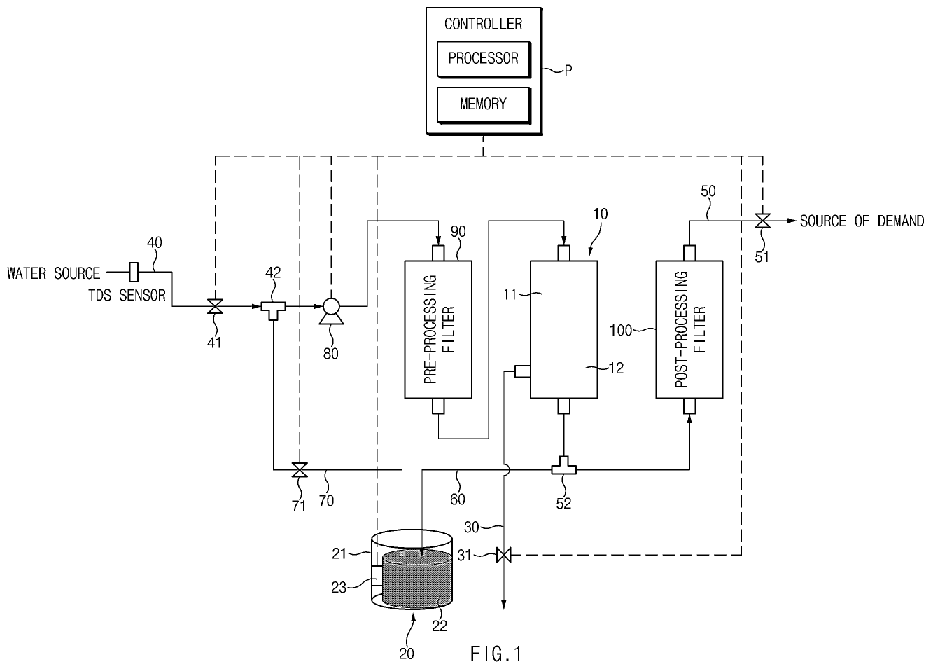

As illustrated in FIG. 1, a water purification system according to an embodiment of the present disclosure may include a filter part 10 and a flushing tank 20. The filter part 10 may be a reverse osmosis filter that may remove ionic substances from source water through reverse osmosis. The filter part 10 may separate the source water into wastewater and purified water and then discharge them.

The filter part 10 may include a source water area 11 and a purified water area 12. The source water delivered from a water source may be supplied to the source water area 11. The purified water area 12 may accommodate purified water. The purified water may be generated by filtering at least a portion of the source water in the source water area 11.

The flushing tank 20 may be configured to receive and store the purified water from the purified water area 12 and supply the stored purified water to the source water area 11.

The technical features of the water purification system according to an embodiment of the present disclosure may be characterized in that at least a portion of the purified water that is introduced from the purified water area 12 into the flushing tank 20, and then is supplied from the flushing tank 20 to the source water area 11 is filtered again, is discharged from the purified water area 12, and then is reintroduced into the flushing tank 20. According to the present disclosure, because at least a portion of the purified water that is supplied from the flushing tank 20 to the source water area 11 is filtered again and is reintroduced into the flushing tank 20, a TDS of the purified water supplied from the flushing tank 20 to the source water area 11 may be lowered. Hereinafter, the remaining structures that make this possible will be described in detail.

The water purification system according to an embodiment of the present disclosure may further include a wastewater line 30 and a wastewater valve 31. The wastewater line 30 may be a line for discharging the wastewater from the source water area 11 to an outside. The wastewater valve 31 may be disposed in the wastewater line 30 to control a flow rate of the wastewater discharged through the wastewater line 30 depending on an opening degree thereof.

The water purification system according to an embodiment of the present disclosure may control a recovery ratio that is a ratio of the purified water and the wastewater that are discharged depending on the opening degree of the wastewater valve 31. A high recovery ratio means that a discharge ratio of the purified water is high. For example, when the wastewater valve 31 is maximally opened, the discharge ratio of the wastewater may increase and the recovery ratio may be minimized.

The water purification system according to an embodiment of the present disclosure may include a water introduction line 40, a water discharge line 50, a flushing tank introduction line 60, and a flushing tank discharge line 70.

The water introduction line 40 may be a line for supplying source water from the water source to the source water area 11. The water discharge line 50 may be a line for discharging the purified water from the purified water area 12 to a source of demand. The water introduction line 40 and the water discharge line 50 may be connected to the filter part 10. The flushing tank introduction line 60 may be a line that is branched from the water discharge line 50 to discharge the purified water into the flushing tank 20. The flushing tank discharge line 70 may be a line for discharging the purified water that is stored in the flushing tank 20 to the source water area 11.

The water purification system according to an embodiment of the present disclosure may include a water introduction valve 41, a water discharge valve 51, a flushing valve 71, and a pump 80.

The water introduction valve 41 may be disposed on the water introduction line 40, and may be disposed on an upstream side of a first connection point 42, at which the water introduction line 40 is connected to the flushing tank discharge line 70. The water introduction valve 41 may selectively block introduction of the source water. A TDS sensor may be disposed in the water introduction line 40 to detect a TDS of the source water that is introduced through the water introduction line.

The water discharge valve 51 may be disposed on the water discharge line 50, and the flushing tank introduction line 60 may be disposed on a downstream of a second connection point 52 that is branched from the water discharge line 50. The water discharge valve 51 may selectively prevent the purified water from being discharged to the source of demand.

The flushing valve 71 may be disposed on the flushing tank discharge line 70 and may selectively open and close the flushing tank discharge line 70 while being opened and closed. When the flushing valve 71 is opened, the water in the flushing tank 20 may be discharged through the flushing tank discharge line 70 and may be introduced into the filter part 10.

The pump 80 is disposed on the water introduction line 40, and may be disposed on a downstream side of the first connection point 42. The pump 80 may pump the water in the water introduction line 40 toward the source water area 11.

A water purification system according to an embodiment of the present disclosure may include a controller “P”. The controller “P” may be configured to control opening and closing of the water introduction valve 41, the water discharge valve 51, the flushing valve 71, and the wastewater valve 31. Furthermore, the controller “P” may be configured to control an operation of the pump 80.

The controller “P” may include a processor and a memory. The processor may include a microprocessor, such as a field programmable gate array (FPGA), an application specific integrated circuit (ASIC), or a central processing unit (CPU). The memory may store control instructions that are the basis for the processor to generate instructions for determining whether to open or close a valve. The memory may be a data storage, such as a hard disk drive (HDD), a solid state drive (SSD), a volatile medium, or a non-volatile medium.

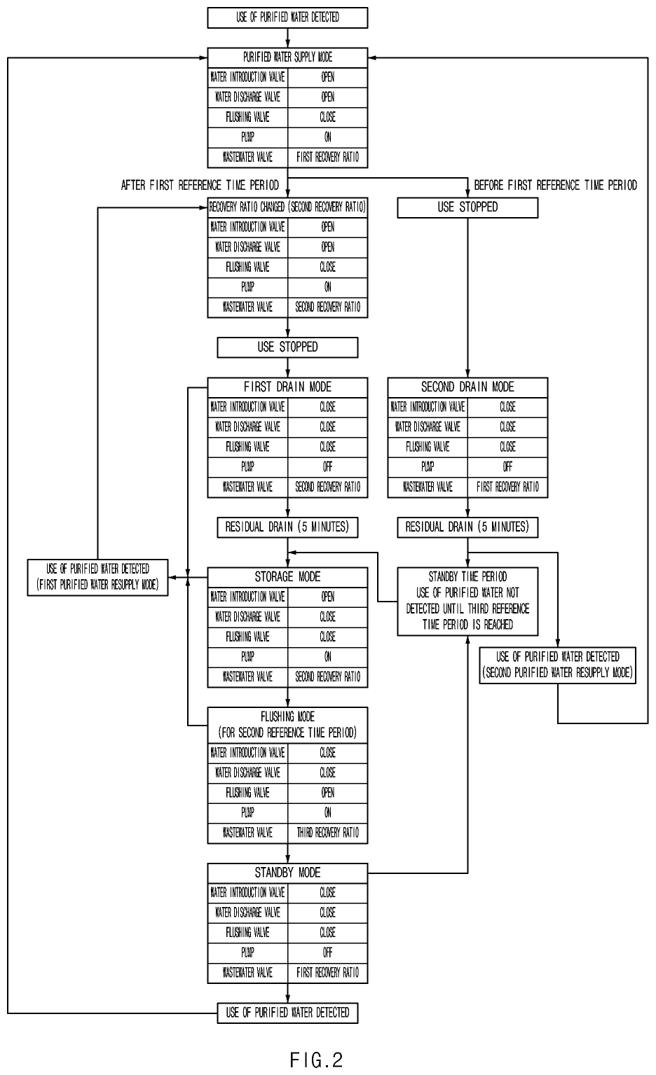

FIG. 2 is a flowchart illustrating an operation sequence of the water purification system according to an embodiment of the present disclosure. Hereinafter, an operation of the water purification system according to an embodiment of the present disclosure will be described in detail based on the above components and FIG. 2.

### Purified Water Supply Mode

TABLE 1

| Water | | | | |
|---|---|---|---|---|
| introduction | Water discharge | Flushing | | Wastewater |
| valve | valve | valve | Pump | valve |
| Opened | Opened | Closed | On | First recovery |
| | | | | ratio |

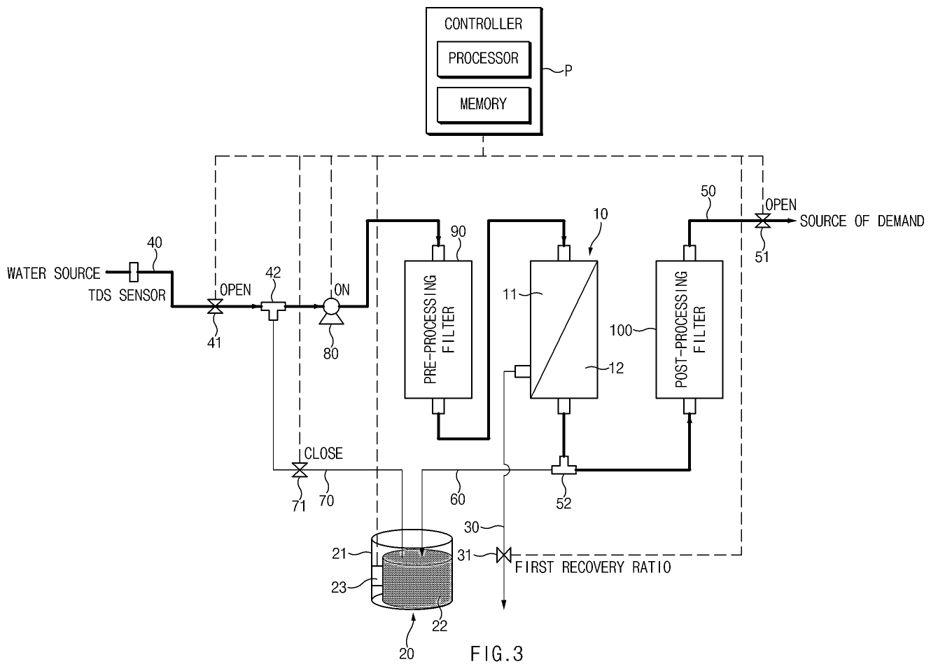

FIG. 3 is a view illustrating a purified water supply mode. The purified water supply mode may be a mode, in which the purified water in the purified water area 12 is supplied to the user. As an example, the purified water supply mode may mean a mode that is entered when the user receives the purified water by pressing a purified water button of a water purifier.

In the purified water supply mode, the water introduction valve 41 and the water discharge valve 51 may be opened. Furthermore, the flushing valve 71 may be closed. An operation of the pump 80 may be initiated to pump the water in the water introduction line 40 to the source water area 11. The wastewater valve 31 may be opened as long as a recovery ratio corresponds to a specific first recovery ratio. As an example, the first recovery ratio may be a ratio of the purified water to the wastewater of 20 to 1. The first recovery ratio may be a recovery ratio, in which a discharge ratio of the wastewater is relatively low.

Meanwhile, the TDS of the source water area 11 continues to increase when the purified water supply mode is maintained for a long time, it may be difficult to maintain the first recovery ratio that has a low discharge ratio of the wastewater. Hereinafter, a case, in which the purified water supply mode is maintained for a specific first reference time period or more will be described in detail. The first reference time period may be 10 seconds.

When the purified water supply mode is maintained for more than the first reference time period,

TABLE 2

| Water | | | | |
|---|---|---|---|---|
| introduction | Water discharge | Flushing | | Wastewater |
| valve | valve | valve | Pump | valve |
| Opened | Opened | Closed | On | Second |
| | | | | recovery ratio |

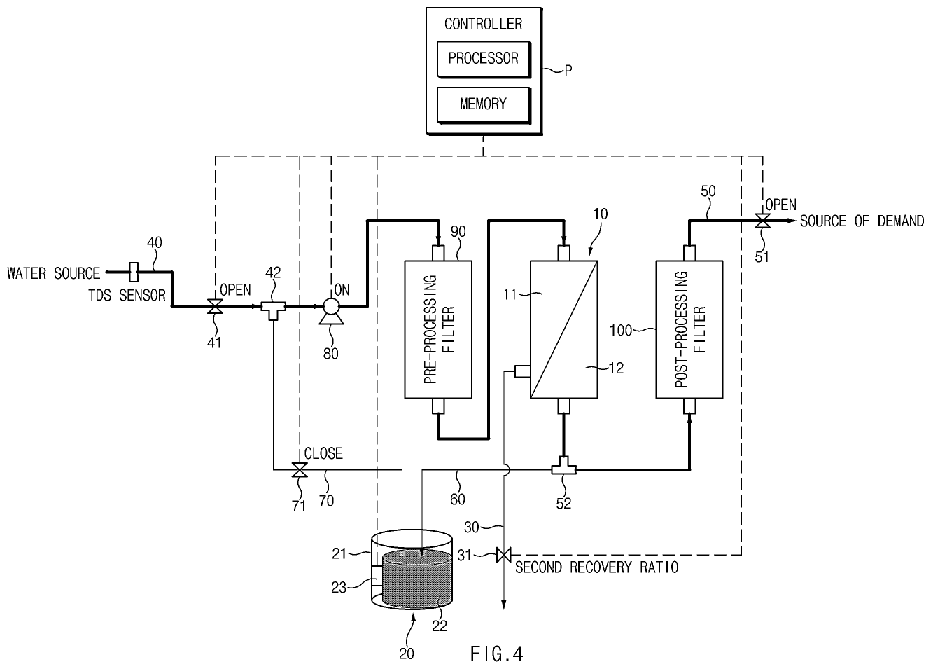

FIG. 4 is a view illustrating that the purified water supply mode is maintained for the first reference time period or more. When the purified water supply mode is maintained for the specific first reference time period or more, the wastewater valve 31 may be opened by a degree, at which the recovery ratio corresponds to the second recovery ratio. The second recovery ratio may be a recovery ratio, in which the discharge ratio of the wastewater is higher than the first recovery ratio. As an example, the second recovery ratio may be a 1 to 1 ratio of the purified water to the wastewater.

Because the discharge ratio of the wastewater is higher at the second recovery ratio than the first recovery ratio, the source water may be wasted. However, because the TDS of the source water area 11 inevitably continues to increase when the first recovery ratio is maintained, it may be advantageous to change the recovery ratio to the second recovery ratio after the first reference time period.

Hereinafter, a state after the first reference time period has elapsed and the purified water supply mode has ended will be described.

### First Drain Mode

TABLE 3

| Water | | | | |
|---|---|---|---|---|
| introduction | Water discharge | Flushing | | Wastewater |
| valve | valve | valve | Pump | valve |
| Closed | Closed | Closed | Off | Second |
| | | | | recovery ratio |

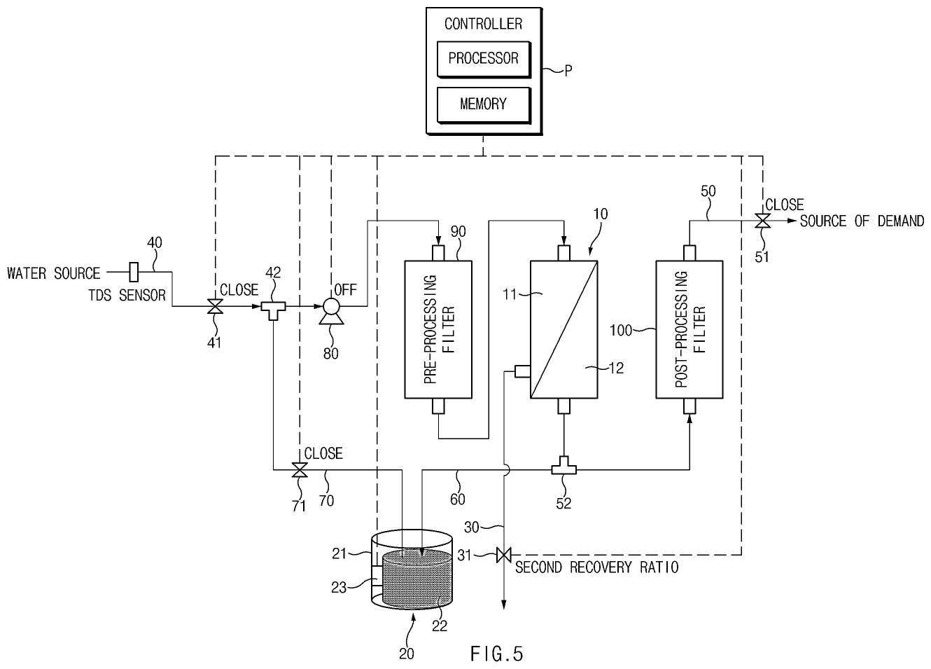

FIG. 5 is a view illustrating a first drain mode. After the purified water supply mode is ended after the first reference time period, the water purification system according to an embodiment of the present disclosure may enter the first drain mode. The first drain mode may be a mode for discharging the wastewater through the wastewater line 30.

In the first drain mode, the water introduction valve 41, the water discharge valve 51, and the flushing valve 71 may be closed. Furthermore, the operation of the pump 80 may be ended in the first drain mode. Furthermore, the wastewater valve 31 may be opened by a degree, at which the recovery ratio corresponds to the second recovery ratio.

The first drain mode may be maintained for a specific period of time. As an example, the first drain mode may be maintained for 5 minutes. In first drain mode, the operation of the pump 80 is ended and the wastewater is slowly discharged through the wastewater line 30 due to a residual pressure, and thus, it needs to be maintained for a sufficient amount of time. When the first drain mode is ended, a storage mode may be entered to store the purified water in the flushing tank 20.

### Storage Mode

TABLE 4

| Water | | | | |
|---|---|---|---|---|
| introduction | Water discharge | Flushing | | Wastewater |
| valve | valve | valve | Pump | valve |
| Opened | Closed | Closed | On | Second |
| | | | | recovery ratio |

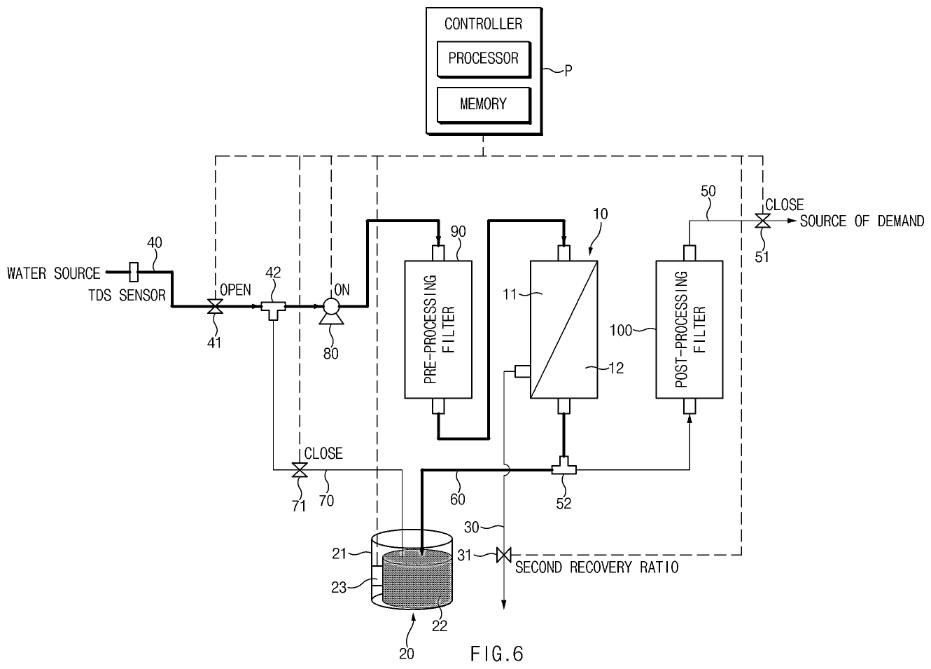

FIG. 6 illustrates a storage mode. When the storage mode is entered, the water introduction valve 41 may be opened. Furthermore, the operation of the pump 80 may be initiated. In this process, at least a portion of the source water that is introduced through the water introduction line 40 becomes purified water and then is stored in the flushing tank 20. When storage of purified water in the flushing tank 20 is ended, a flushing mode for sending the stored purified water to the filter part 10 may be entered.

### Flushing Mode

TABLE 5

| Water | | | | |
|---|---|---|---|---|
| introduction | Water discharge | Flushing | | Wastewater |
| valve | valve | valve | Pump | valve |
| Closed | Closed | Opened | On | Third recovery |
| | | | | ratio |

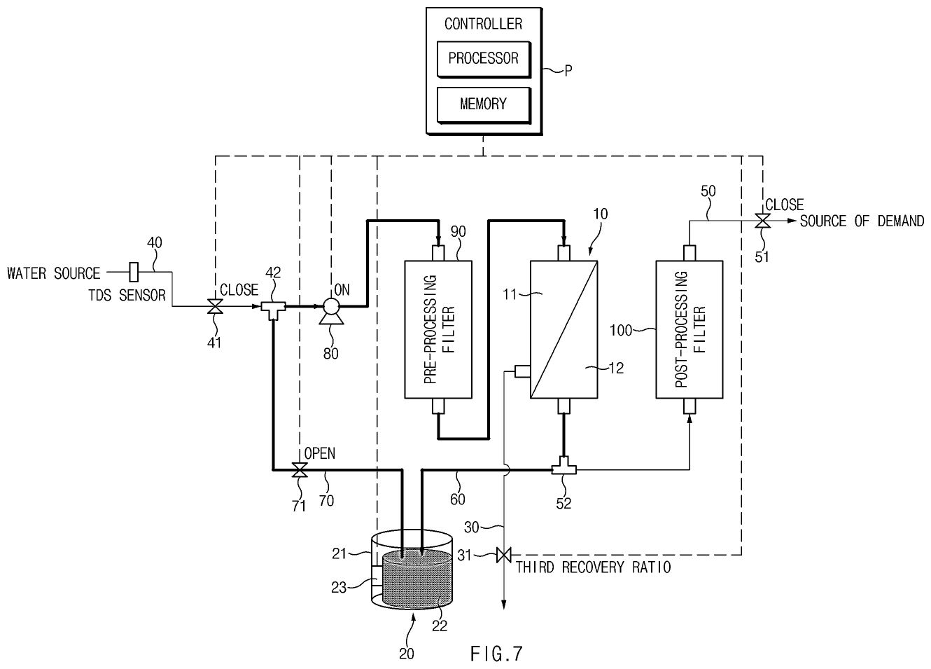

FIG. 7 is a view illustrating a flushing mode. When storage of purified water in the flushing tank 20 is ended and the flushing mode for sending the stored purified water to the filter part 10 is entered, the water introduction valve 41 may be closed. Furthermore, the flushing valve 71 may be opened.

The wastewater valve 31 may be opened by a degree corresponding to a third recovery ratio. The third recovery ratio may be a recovery ratio, in which a discharge ratio of the wastewater is higher than the first recovery ratio and the discharge ratio of the wastewater is lower than the second recovery ratio. As an example, the third recovery ratio may be a ratio of the purified water to wastewater of 4.8 to 1.

In the flushing mode, the purified water stored in the flushing tank 20 may be introduced into the source water area 11 of the filter part 10. Furthermore, some of the purified water flowing into the source water area 11 may be filtered again and be reintroduced into the flushing tank 20. The reintroduced purified water may be reintroduced into the source water area 11. As this circulation process continues, the TDS of the water introduced into the flushing tank 20 may continue to decrease.

The flushing mode may be maintained for a specific second reference time period. As an example, the second reference time period may be 60 seconds. After flushing mode is maintained for the second reference time period, a standby mode may be entered.

### Standby Mode

TABLE 6

| Water | | | | |
|---|---|---|---|---|
| introduction | Water discharge | Flushing | | Wastewater |
| valve | valve | valve | Pump | valve |
| Closed | Closed | Closed | Off | First recovery |
| | | | | ratio |

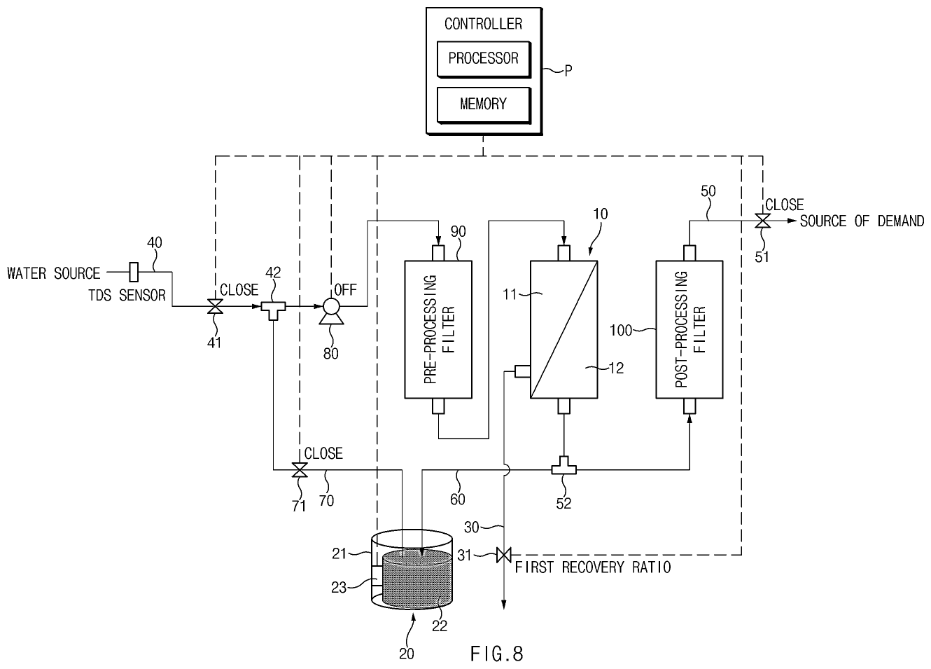

FIG. 8 is a view illustrating a standby mode. When the flushing mode is maintained for a specific second reference time period and then the standby mode is entered, the flushing valve 71 may be closed. Furthermore, the operation of the pump 80 may be ended. The wastewater valve 31 may be opened by a degree corresponding to the first recovery ratio. The standby mode may be understood as a state for entering the purified water supply mode. That is, because the TDS of the source water area 11 is sufficiently low, the wastewater valve 31 may be opened again by a degree, at which the recovery ratio corresponds to the first recovery ratio.

When the standby mode is maintained for a specific third reference time period, the storage mode may be reentered. For example, the third reference time period may be 6 hours. When the standby mode is maintained for a long time, a situation, in which the TDS of the purified water area 12 increases again, may occur. Accordingly, when a sufficient time has passed, the TDS of the purified water area 12 may be lowered by performing the storage mode and the flushing mode again.

### First Purified Water Resupply Mode

TABLE 7

| Water | | | | |
|---|---|---|---|---|
| introduction | Water discharge | Flushing | | Wastewater |
| valve | valve | valve | Pump | valve |
| Opened | Opened | Closed | On | Second |
| | | | | recovery ratio |

Meanwhile, the first purified water resupply mode may be entered while the first drain mode, the storage mode, or the flushing mode is performed. The first purified water resupply mode may be a mode, in which the purified water has to be supplied to an outside while the first drain mode, the storage mode, or the flushing mode is performed. For example, it may be assumed that an external user presses the purified water supply button of the water purifier while the first drain mode, storage mode, or flushing mode is performed.

In this case, the water introduction valve 41 and the water discharge valve 51 may be opened and the flushing valve 71 may be closed. Furthermore, the operation of the pump 80 may be initiated to pump the water in the water introduction line 40 to the filter part 10. Then, the recovery ratio of the wastewater valve 31 may correspond to the second recovery ratio. This may be the same as the state of FIG. 4.

In other words, when the purified water resupply mode is entered in the first drain mode, the storage mode, or the flushing mode, the TDS of the source water area 11 is not sufficiently low, and thus, the wastewater valve 31 may be opened by a degree, at which the recovery ratio corresponds to the second recovery ratio.

### Second Drain Mode

TABLE 8

| Water | | | | |
|---|---|---|---|---|
| introduction | Water discharge | Flushing | | Wastewater |
| valve | valve | valve | Pump | valve |
| Closed | Closed | Closed | Off | First recovery |
| | | | | ratio |

Hereinafter, a case, in which the purified water supply mode is maintained for less than the first reference time period will be described in detail. When the purified water supply mode is maintained relatively shortly, it may be possible to maintain the first recovery ratio with a low discharge ratio of the wastewater. Accordingly, there may be no need to open the wastewater valve 31 by a degree, at which the recovery ratio corresponds to the second recovery ratio.

Meanwhile, when the purified water supply mode is ended before the first reference time period has elapsed, the second drain mode may be entered. The second drain mode may be a mode for discharging the wastewater through the wastewater line 30.

In the second drain mode, the water introduction valve 41, the water discharge valve 51, and the flushing valve 71 may be closed. Furthermore, the operation of the pump 80 may be ended. The wastewater valve 31 may be opened by a degree, at which the recovery ratio corresponds to a specific first recovery ratio. This may be understood as a state, in which the second recovery ratio has been changed to the first recovery ratio in FIG. 5.

Meanwhile, when the purified water resupply mode is not entered within the third reference time period after the second drain mode, the storage mode for storing the purified water in the flushing tank 20 may be entered. Furthermore, when the storage mode is ended, the flushing mode may be entered.

### Second Resupply Mode (Same as Purified Water Supply Mode)

TABLE 9

| Water | | | | |
|---|---|---|---|---|
| introduction | Water discharge | Flushing | | Wastewater |
| valve | valve | valve | Pump | valve |
| Opened | Opened | Closed | On | First recovery |
| | | | | ratio |

After the second drain mode, the second purified water resupply mode may be entered within the third reference time period. The second purified water resupply mode may be a mode, in which the purified water has to be supplied to an outside within a third reference time period after the second drain mode.

For example, it may be assumed that an external user presses the purified water supply button of the water purifier within the third reference time period after the second drain mode.

In the second purified water resupply mode, the water introduction valve 41 and the water discharge valve 51 may be opened. In the second purified water resupply mode, the flushing valve 71 may be closed. Furthermore, the operation of the pump 80 may be initiated in the second purified water resupply mode. The wastewater valve 31 may be opened by a degree, at which the recovery ratio corresponds to the first recovery ratio. The second purified water resupply mode may be understood as the same operation state as that of the purified water supply mode. That is, it may be in the same state as the state of FIG. 3.

### <Pre-Processing Filter 90, Post-Processing Filter 100>

The water purification system according to an embodiment of the present disclosure may further include a pre-processing filter 90 and a post-processing filter 100. The pre-processing filter 90 may be disposed in the water introduction line 40. In more detail, the pre-processing filter 90 may be disposed on the downstream side of the first connection point 42 and on the upstream side of the part connected to the filter part 10 of the water introduction line 40.

The pre-processing filter 90 may be a pre-carbon filter, a sediment filter, a high turbidity filter, a composite filter combining a sediment filter, a pre-carbon filter, and the like. The pre-processing filter 90 may remove large foreign substances and may remove chlorine, organic compounds, odors and pigments through adsorption as well.

The post-processing filter 100 may be disposed in the water discharge line 50. In more detail, the post-processing filter 100 may be disposed on the upstream side of a portion of the water discharge line 50, at which the water discharge valve 51 is disposed, and may be disposed on the downstream side of the second connection point 52.

The post-processing filter 100 may be a granular activated carbon (GAC) filter, a block carbon filter, a silver carbon filter, a deionization resin (DR) filter), a taste chlorine reduction (TCR) filter, and the like. The post-processing filter 100 may improve the taste of the water by adsorbing fine substances and removing gas components and odors.

### <Specific Structure of Flushing Tank 20>

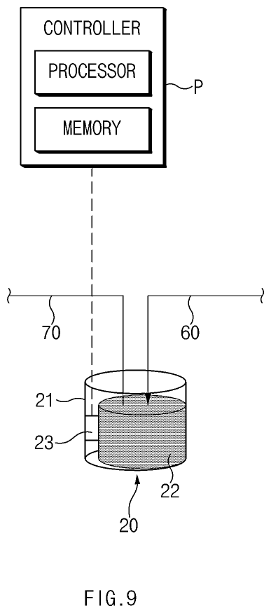

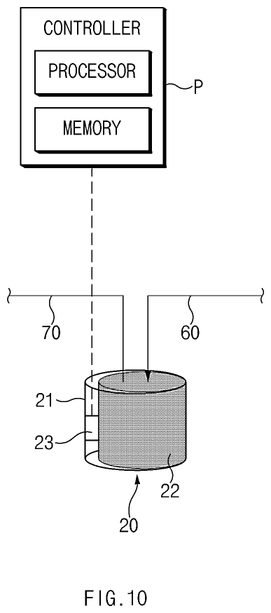

FIGS. 9 and 10 are enlarged views of the flushing tank.

As illustrated in FIGS. 9 and 10, the flushing tank 20 may include an outer tank 21 and an inner tank 22. A space may be formed in an interior of the outer tank 21. The outer tank 21 may be a closed tank, through which the flushing tank introduction line 60 and the flushing tank discharge line 70 pass.

The inner tank 22 may be inserted into the outer tank 21. The inner tank 22 may be connected to the flushing tank introduction line 60 and the flushing tank discharge line 70, and a volume thereof may be changeable by an amount of the water introduced from the flushing tank introduction line 60 and an amount of the water discharged through the flushing tank discharge line 70. The inner tank 22 may be formed of an elastically deformable material. FIG. 10 may be understood as illustrating a state, in which the volume of the inner tank 22 is increased.

Because the flushing tank 20 has a dual structure including the outer tank 21 and the inner tank 22, it may minimize contamination as a closed tank, and there may be no need for separate introduction for discharging the water.

The flushing tank 20 may further include a pressure sensor 23. The pressure sensor 23 may be attached to the inner wall of the outer tank 21 and be configured to detect a change in the applied pressure. As an example, when the water is introduced into the inner tank 22 and the volume of the inner tank 22 increases, the pressure applied to the pressure sensor 23 may increase. Then, when the pressure acquired by the pressure sensor 23 is higher than a specific reference pressure, it may be determined that the tank is full.

The controller “P” may control the opening and closing of the water introduction valve 41, the flushing valve 71, and the wastewater valve 31 based on the pressure value acquired by the pressure sensor 23.

In more detail, the controller “P” may determine that the water is full when the pressure acquired by the pressure sensor 23 is a specific reference pressure or more, and may control the water introduction valve 41 to close the water introduction valve 41 that has been opened to perform the flushing mode.

Furthermore, the controller “P” may control the flushing valve 71 to open the closed flushing valve 71.

Furthermore, the controller “P” may control the opening degree of the wastewater valve 31 to decrease the flow rate of the wastewater discharged through the wastewater line 30. As an example, the controller “P” may change the opening degree of the wastewater valve 31 so that the recovery ratio is converted from the second recovery ratio to the third recovery ratio.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

1. A water purification system comprising:
a filter part having a source water area for receiving source water and a purified water area for accommodating purified water generated by filtering at least a portion of the source water of the source water area, and configured to separate and discharge the source water into wastewater and the purified water; and
a flushing tank configured to receive and store the purified water of the purified water area, and supply the stored purified water to the source water area,
wherein at least a portion of the purified water introduced from the purified water area into the flushing tank, and then supplied from the flushing tank to the source water area is filtered again, discharged from the purified water area, and then reintroduced into the flushing tank.

2. The water purification system of claim 1, further comprising:
a wastewater line, through which the waste water of the source water area is discharged to an outside; and
a wastewater valve disposed in the wastewater line, and configured to control a flow rate of the wastewater discharged through the wastewater line depending on an opening degree thereof,
wherein a recovery ratio being a ratio of the purified water and the wastewater discharged is controlled depending on the opening degree of the wastewater valve.

3. The water purification system of claim 2, further comprising:
a water introduction line, through which the source water is supplied from the water source to the source water area;
a water discharge line, through which the purified water of the purified water area is discharged to a source of demand;
a flushing tank introduction line branched from the water discharge line, and through which the purified water is discharged to the flushing tank; and
a flushing tank discharge line, through which the stored purified water of the flushing tank is discharged to the source water area.

4. The water purification system of claim 3, further comprising:
a water introduction valve disposed in the water introduction line, in which the water introduction line is disposed on an upstream side of a first connection point connected to the flushing tank discharge line, and configured to selectively block introduction of the source water;
a water discharge valve disposed in the water discharge line, in which the flushing tank introduction line is disposed on a downstream side of a second connection point branched from the water discharge line, and configured to selectively block discharge of the purified water to the source of demand;
a flushing valve disposed in the flushing tank discharge line, and configured to selectively open and close the flushing tank discharge line while being opened and closed; and
a pump disposed in the water introduction line, disposed on a downstream side of the first connection point, and configured to pump water in the water introduction line toward the source water area.

5. The water purification system of claim 4, wherein in a purified water supply mode for supplying the purified water in the purified water area to a user,
the water introduction valve and the water discharge valve are opened,
the flushing valve is closed,
an operation of the pump is initiated to pump the water in the water introduction line to the source water area, and
the wastewater valve is opened by a degree, at which the recovery ratio corresponds to a first recovery ratio.

6. The water purification system of claim 5, wherein when the purified water supply mode is maintained for a first reference time period,
the wastewater valve is opened by a degree, at which the recovery ratio corresponds to a second recovery ratio being a recovery ratio, at which a discharge ratio of the wastewater is higher than the first recovery ratio.

7. The water purification system of claim 6, wherein when the purified water supply mode is ended after the first reference time period and then a first drain mode for discharging the wastewater through the wastewater line is entered,
the water introduction valve, the water discharge valve, and the flushing valve are closed,
the operation of the pump is ended, and
the wastewater valve is opened by a degree, at which the recovery ratio corresponds to the second recovery ratio.

8. The water purification system of claim 7, wherein after the first drain mode is ended and then a storage mode for storing the purified water in the flushing tank is entered,
the water introduction valve is opened, and
the operation of the pump is initiated.

9. The water purification system of claim 8, wherein when storage of the purified water in the flushing tank is ended, and then a flushing mode for sending the stored purified water to the filter part is entered,
the water introduction valve is closed,
the flushing valve is opened, and
the wastewater valve is opened by a degree, at which the recovery ratio corresponds to a third recovery ratio being a recovery ratio, at which a discharge ratio of the wastewater is higher than the first recovery ratio and the discharge ratio of the wastewater is lower than the second recovery ratio.

10. The water purification system of claim 9, wherein when a first purified water resupply mode for supplying the purified water to an outside in the first drain mode, the storage mode, or the flushing mode is entered,
the water introduction valve and the water discharge valve are opened,
the flushing valve is closed,
the operation of the pump is initiated to pump the water in the water introduction line to the filter part, and
the wastewater valve is opened by a degree, at which the recovery ratio corresponds to the second recovery ratio.

11. The water purification system of claim 9, wherein when the flushing mode is maintained for a second reference time period and then a standby mode is entered,
the flushing valve is closed,
the operation of the pump is ended, and
the wastewater valve is opened by a degree, at which the recovery ratio corresponds to the first recovery ratio.

12. The water purification system of claim 11, wherein the storage mode is configured to be reentered when the standby mode is maintained for a third reference time period.

13. The water purification system of claim 6, wherein when the purified water supply mode is ended before the first reference time period elapses and then a second drain mode for discharging the wastewater through the wastewater line is entered,
the water introduction valve, the water discharge valve, and the flushing valve are closed,
the operation of the pump is ended, and
the wastewater valve is opened by a degree, at which the recovery ratio corresponds to the first recovery ration.

14. The water purification system of claim 13, wherein when, after the second drain mode, a second purified water resupply mode for supplying the purified water to an outside within the third reference time period is not entered and a storage mode for storing the purified water to the flushing tank is entered,
the water introduction valve is opened,
the operation of the pump is initiated, and
the wastewater valve is opened by a degree, at which the recovery ratio corresponds to the second recovery ratio being a recovery ratio, at which a discharge ratio of the wastewater is higher than the first recovery ratio.

15. The water purification system of claim 14, wherein when storage of the purified water in the flushing tank is ended and then a flushing mode for sending the stored purified water to the filter part is entered,
the water introduction valve and the flushing valve are opened, and
the wastewater valve is opened by a degree, at which the recovery ratio corresponds to the second recovery ratio being a recovery ratio, at which a discharge ratio of the wastewater is higher than the first recovery ratio.

16. The water purification system of claim 13, wherein when, after the second drain mode, a second purified water resupply mode for supplying the purified water to an outside within the third reference time period is entered,
the water introduction valve and the water discharge valve are opened, and
the operation of the pump is initiated.

17. The water purification system of claim 3, wherein the flushing tank includes:
an outer tank having a space in an interior thereof; and
an inner tank inserted into an interior of the outer tank, connected to the flushing tank introduction line and the flushing tank discharge line, and a volume of which is changeable by an amount of the water introduced from the flushing tank introduction line and an amount of the water discharged through the flushing tank discharge line.

18. The water purification system of claim 17, wherein the flushing tank further includes:
a pressure sensor attached to an inner wall of the outer tank, and configured to detect a change in the applied pressure.

19. The water purification system of claim 18, further comprising:
a water introduction valve disposed in the water introduction line, the water introduction line being disposed on an upstream side of a first connection point connected to the flushing tank discharge line, and configured to selectively block introduction of the source water;
a flushing valve disposed in the flushing tank discharge line, and configured to selectively open and close the flushing tank discharge line while being opened and closed;
a wastewater valve disposed in the wastewater line, and configured to control the flow rate of the wastewater discharged through the wastewater line depending on an opening degree thereof, and
a controller configured to control opening and closing of the water introduction valve, the flushing valve, and the wastewater valve based on the pressure acquired by the pressure sensor.

20. The water purification system of claim 19, wherein the controller is configured to:
when the pressure acquired by the pressure sensor is a reference pressure or higher,
control the water introduction valve to close the opened water introduction valve;
control the flushing valve to open the closed flushing valve; and
control an opening degree of the wastewater valve to decrease the flow rate of the wastewater discharged through the wastewater line.
